(19) United States
(12) Patent Application Publication
(10) Pub. No.: US 2017/0181200 A1
(43) Pub. Date: Jun. 22, 2017

(54) SYSTEM AND METHOD FOR EMERGENCY SECURE USER PLANE LOCATION POSITIONING

(71) Applicant: Intel IP Corporation, Santa Clara, CA (US)

(72) Inventor: Murugan Natesan, Bangalore (IN)

(21) Appl. No.: 14/978,285

(22) Filed: Dec. 22, 2015

(51) Int. Cl. H04W 76/02; H04W 12/08

(52) U.S. Cl. CPC H04W 76/02; H04W 12/08

(57) ABSTRACT

In a modem and a communication method, an emergency packet data network (PDN) is established by an internet protocol multimedia subsystem (IMS) stack during Voice over LTE (VoLTE) Emergency Call. A secure connection can be established with a position assistance server based on the emergency PDN using a secure user plane location (SUPL) socket. Further, SUPL messages can be exchanged with the position assistance server (e.g., a SUPL Server) via the secure connection using the SUPL socket.

### BACKGROUND

Field

Aspects described herein generally relate to positioning for emergency wireless communications, including positioning using secure user plane location (SUPL) positioning.

Related Art

The Global Positioning System (GPS) is a global navigation satellite systems (GNSS) that provides location and time information to receivers on Earth. Other countries have implemented or are planning to implement similar systems, including, for example, the Russian Global Navigation Satellite System (GLONASS), the European Union Galileo positioning system (GALILEO), the Japanese Quasi-Zenith Satellite System (QZSS), the Chinese BeiDou navigation system, and the Indian Regional Navigational Satellite System (IRNSS).

GNSS systems use radio signals transmitted by orbiting satellites to determine precise ground locations, enabling advanced navigation and location-based services. Typically, a GNSS receiver determines its position based on the timing of messages received from at least four GNSS satellites. Each message specifies the time of transmission and the position of the satellite at the time of transmission. The receiver can calculate its location using navigation equations by calculating the time of transit for each received. The location can then be, for example, displayed on an electronic map or provided to another application.

Using satellite signals to perform a location determination can be time consuming. For example, a GPS receiver often requires up to several minutes to compute an initial position. Accordingly, assisted GPS (“A-GPS”) can be used to reduce the time-to-first-fix. The user equipment, such as a mobile phone, can obtain data from an A-GPS server using, for example, cellular or other wireless communication protocols. The data obtained can include orbital data for GPS satellites and can reduce the time required to lock onto signals and decode the data broadcast by the satellites. In some cases, the user equipment can provide partial information to an A-GPS server, which can then calculate the location for the user equipment. This has the added benefit of reducing the workload of the user equipment.

In operation, the location of the communication device (e.g., mobile device) can be provided to the supporting service provider in certain circumstances. Location reporting can use control plane positioning or user plane positioning. The location reporting process can include, for example, periodic location reporting by the operating system of the communication device, location reporting initiated by one or more applications running on the communication device, and/or location reporting by the communication device during an emergency call (e.g., a call to 911).

### BRIEF DESCRIPTION OF THE DRAWINGS/FIGURES

The accompanying drawings, which are incorporated herein and form a part of the specification, illustrate the aspects of the present disclosure and, together with the description, further serve to explain the principles of the aspects and to enable a person skilled in the pertinent art to make and use the aspects.

FIG. 1 illustrates a satellite positioning system according to exemplary aspects of the present disclosure.

FIG. 2A illustrate an assistance server according to exemplary aspects of the present disclosure.

FIG. 2B illustrate a communication device according to exemplary aspects of the present disclosure.

FIG. 3 illustrates a communication device according to an exemplary aspect of the present disclosure.

FIG. 4 illustrates a communication device according to an exemplary aspect of the present disclosure.

FIG. 5 illustrates a communication method according to an exemplary aspect of the present disclosure.

The exemplary aspects of the present disclosure will be described with reference to the accompanying drawings. The drawing in which an element first appears is typically indicated by the leftmost digit(s) in the corresponding reference number.

### DETAILED DESCRIPTION

In the following description, numerous specific details are set forth in order to provide a thorough understanding of the aspects of the present disclosure. However, it will be apparent to those skilled in the art that the aspects, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

### Exemplary Satellite System

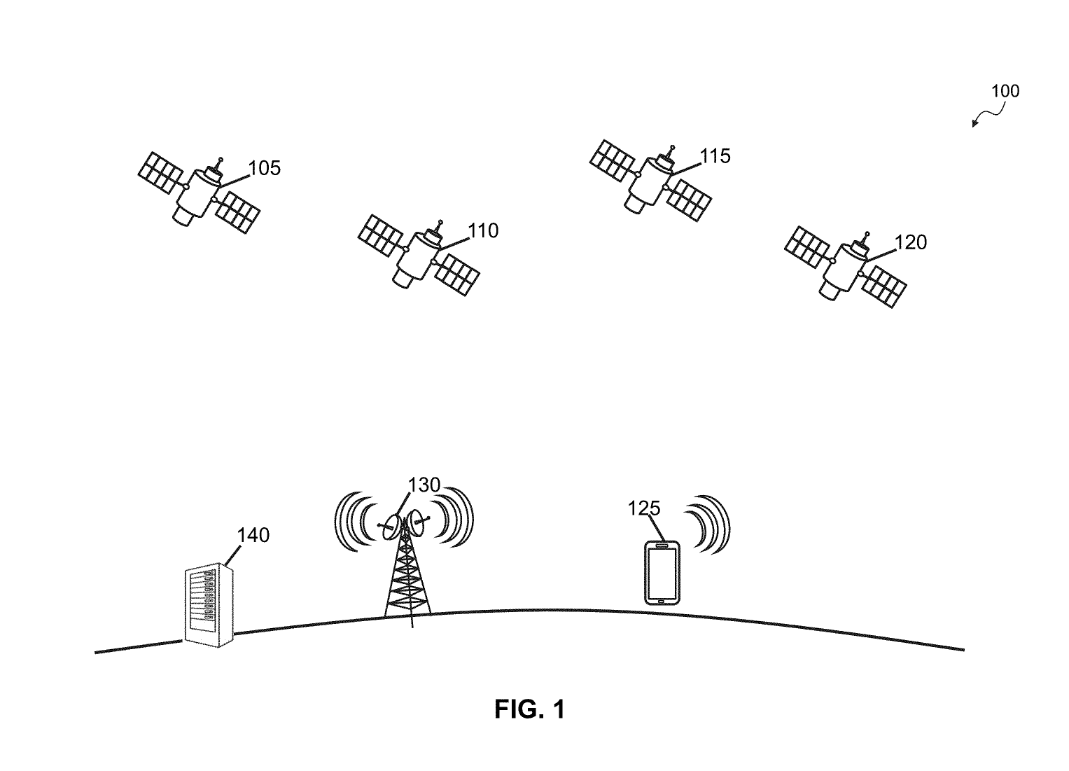

FIG. 1 illustrates an example satellite positioning system 100 according to an exemplary aspect of the present disclosure. The satellite positioning system 100 can include one or more user devices 125, one or more positioning satellites (e.g., positioning satellites 105, 110, 115, and 120), a wireless communication tower 130, and an Assisted GPS (A-GPS) server 140.

The user device 125 can include processor circuitry that is configured to determine its location in response to signals from one or more sources, such as positioning satellites 105, 110, 115, and/or 120. The user device 125 can be any electronic device that includes or interfaces with a GNSS receiver and that is configured to determine its location in response to signals from one or more sources as will be apparent to those skilled in the relevant arts without departing from the spirit and scope of the present disclosure. For example, the user device 125 can be a mobile communication device, such as a cellular telephone or smartphone. In some exemplary aspects, the user device 125 can be configured to determine its position with respect to any or all of latitude, longitude, and altitude. In other aspects, one or more other coordinate systems or positional representations can be used in addition to or in place of latitude, longitude, and/or altitude.

The positioning satellites 105, 110, 115, and 120 can be configured to conform with a single positioning system, such as Navstar GPS, Global Navigation Satellite System (GLONASS), and the GALILEO global navigation system. In other exemplary aspects, one or more of the positioning satellites can be associated with a different positioning system than one or more of the other satellites.

The user device 125 is configured to receive signals from positioning satellites (e.g., 105, 110, 115, and/or 120) in the satellite positioning system 100 and to use received signals to determine the position of the user device 125. For example, the user device 125 can estimate its position using measurements of its range from a number of the positioning satellites, and to extract broadcast ephemeris data from the received signals. The ephemeris data can include navigational information of the positioning satellites, such as satellite orbit models, clock models, and/or information about the operational status of the positioning satellites. In operation, the navigational information can be utilized in determining, for example, a position fix and/or the velocity of the user device 125. Typically, the broadcast ephemeris is valid for a limited period of time (e.g., two to four hours from the time of broadcast). Before the end of the validity period, the user device 125 can obtain a fresh broadcast ephemeris to continue positional determinations. The range between the user device 125 and the transmitting positioning satellite can be measured based on the time it takes the message to travel from the positioning satellite to the user device 125.

The user device 125 (also referred herein as communication device 125) can be configured to communicate with one or more assistance servers (e.g., A-GPS server 140) utilizing one or more communication standards or protocols as would be understood by those of ordinary skill in the art. The communication device 125 can also be configured to communicate with one or more communication towers 130 to obtain information to assist in positional determinations. The communication tower 130 can be, for example, a cellular tower of a cellular network, a wireless local area network (WLAN) access point, etc.

The communication tower 130 can transmit assistance data from the assistance server 140 to the communication device 125. The assistance data can include, for example, the current time, the position of one or more satellites, clock offset data for the one or more satellites, and/or an estimate of the location of communication device 125 based on, for example, the location of one or more of the wireless communication towers 130. In some other implementations, the communication tower 130 can estimate the position of the communication device 125, either alone or in combination with one or more other communication towers 130 using, for example, signal strength observations or time-of-flight and/or angle-of-arrival calculations using signals transmitted by the communication device 125.

### Exemplary Assisted GPS Server

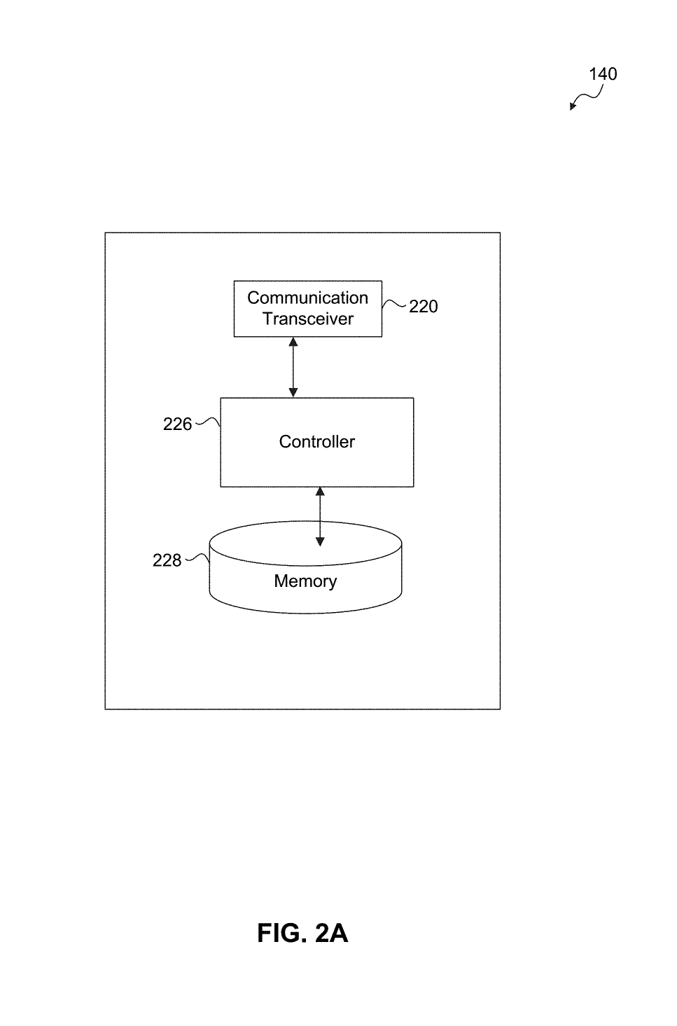

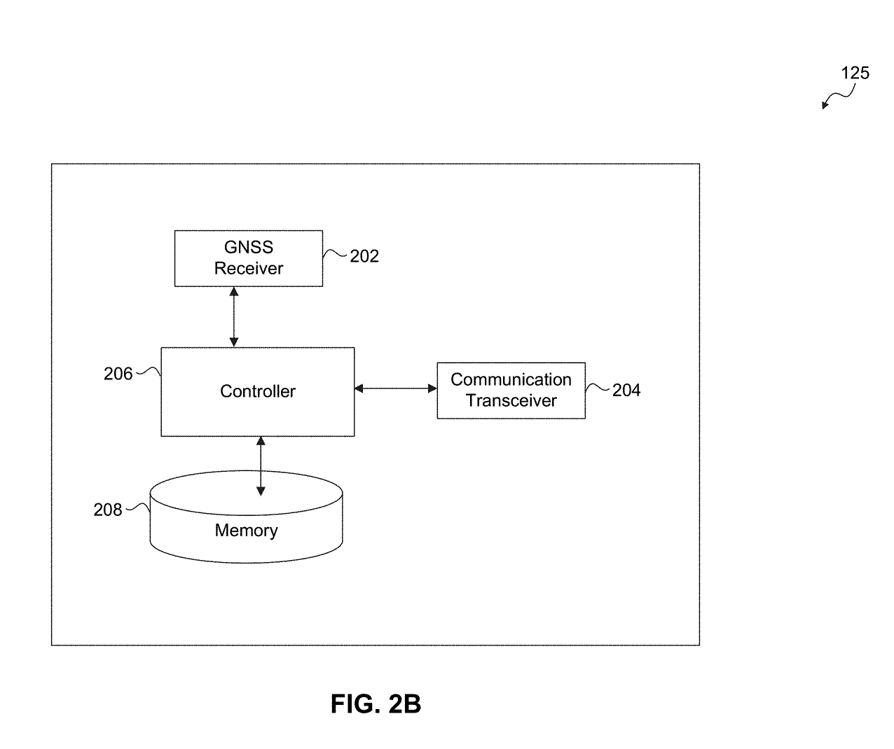

In an exemplary aspect, the communication device 125 can communicate with position assistance server 140 (also referred herein as A-GPS server 140) to reduce the time required to determine a position and/or to reduce the amount of processing required to be performed by the communication device 125. An exemplary aspect of the A-GPS server 140 is illustrated in FIG. 2A. The position assistance server 140 (A-GPS server 140) is not limited to the GPS technology, and it can be configured for one or more other GNSS technologies, including, for example, the GLONASS, GALILEO, QZSS, BeiDou navigation system, IRNSS, and/or one or more other satellite positioning technologies as would be understood by one of ordinary skill in the relevant arts. That is, the position assistance server 140 is referred to as the A-GPS server for the purpose of this discussion, but it is not limited thereto.

A-GPS server 140 can include memory 228 that stores information associated with positioning satellites (e.g., orbital information), which can be downloaded by the communication device 125. This information can be referred to as position assistance data. Further, the A-GPS server 140 can include a communication transceiver 220 configured to communicate with the communication device 125 via one or more communication protocols (e.g., WLAN, LTE, etc.). The communication transceiver 220 can include processor circuitry configured to transmit and/or receive wireless communications via one or more communication protocols. The memory 228 can be any well-known volatile and/or non-volatile memory that stores data and/or instructions. The memory 208 can include, for example, read-only memory (ROM), random access memory (RAM), flash memory, a magnetic storage media, an optical disc, erasable programmable read only memory (EPROM), and programmable read only memory (PROM). The memory 208 can be non-removable, removable, or a combination of both. In an exemplary aspect, the memory 208 can also include processor circuitry.

The communication device 125 can use the information provided by the A-GPS server to reduce the time required to determine its location. For example, the communication device 125 can determine one or more satellite locations from the A-GPS data, instead of waiting to decode similar data received from satellites. The A-GPS data can assist signal processing algorithms by reducing the search time to obtain a satellite signal.

In some exemplary aspects, the communication device 125 can be configured to offload processing to the A-GPS server 140 by uploading information—such as, satellite signal time of arrival information, information on one or more received satellite signals, one or more coarse positions of the communication device 125, and/or other information as would be understood by those skilled in the arts—to the A-GPS server 140. The coarse position can be based on, for example, historical position data of the communication device 125 (e.g., last known position), geographical information (e.g., terrain information), and/or other information as would be understood by those skilled in the relevant arts.

The A-GPS server 140 can include a controller 226. The controller 226 can include processor circuitry that is configured to control the overall operation and/or configuration of the A-GPS server 140, generate a navigation solution, such as a position fix and/or velocity of the communication device 125, and provide the navigation solution to the communication device 125.

### Exemplary Communication Devices

FIG. 2B illustrates a schematic diagram of an exemplary communication device 125 according to an exemplary aspect of the present disclosure. The communication device 125 can be a GNSS enabled communication device that is configured to determine its location in response to signals from one or more sources. For example, the communication device 125 can be configured to determine its position from GNSS signals received from one or more positioning satellites (e.g., 105, 110, 115, and 120).

The communication device 125 can include a GNSS receiver 202, a communication transceiver 204, a controller 206, and a memory 208.

The GNSS receiver 202 can include processor circuitry that is configured to receive GNSS signals from one or more GNSS satellites. In an exemplary aspect, the processor circuitry of the GNSS receiver 202 includes one or more transceivers configured to communicate with one or more satellites.

The controller 206 can include processor circuitry that is configured to control overall operation and/or configuration of the communication device 125 and to process GNSS signals from the GNSS receiver 202 to calculate a navigation solution, such as a position fix and/or velocity of the communication device 125.

The communication transceiver 204 includes processor circuitry that is configured to transmit and/or receive radio signals over one or more communication protocols (e.g., via communication tower 130). The controller 206 can be configured to facilitate communication with one or more communication networks and/or with one or more external devices (e.g., server 140). Further, the controller 206 can be configured to process communication signals transmitted/received by the communication transceiver 204 via the communication tower 130 to calculate a navigation solution and/or to assist in the calculation of the navigation solution calculated using the GNSS signals.

The memory 208 can be any well-known volatile and/or non-volatile memory that stores data and/or instructions. The memory 208 can include, for example, read-only memory (ROM), random access memory (RAM), flash memory, a magnetic storage media, an optical disc, erasable programmable read only memory (EPROM), and programmable read only memory (PROM). The memory 208 can be non-removable, removable, or a combination of both. In an exemplary aspect, the memory 208 can also include processor circuitry.

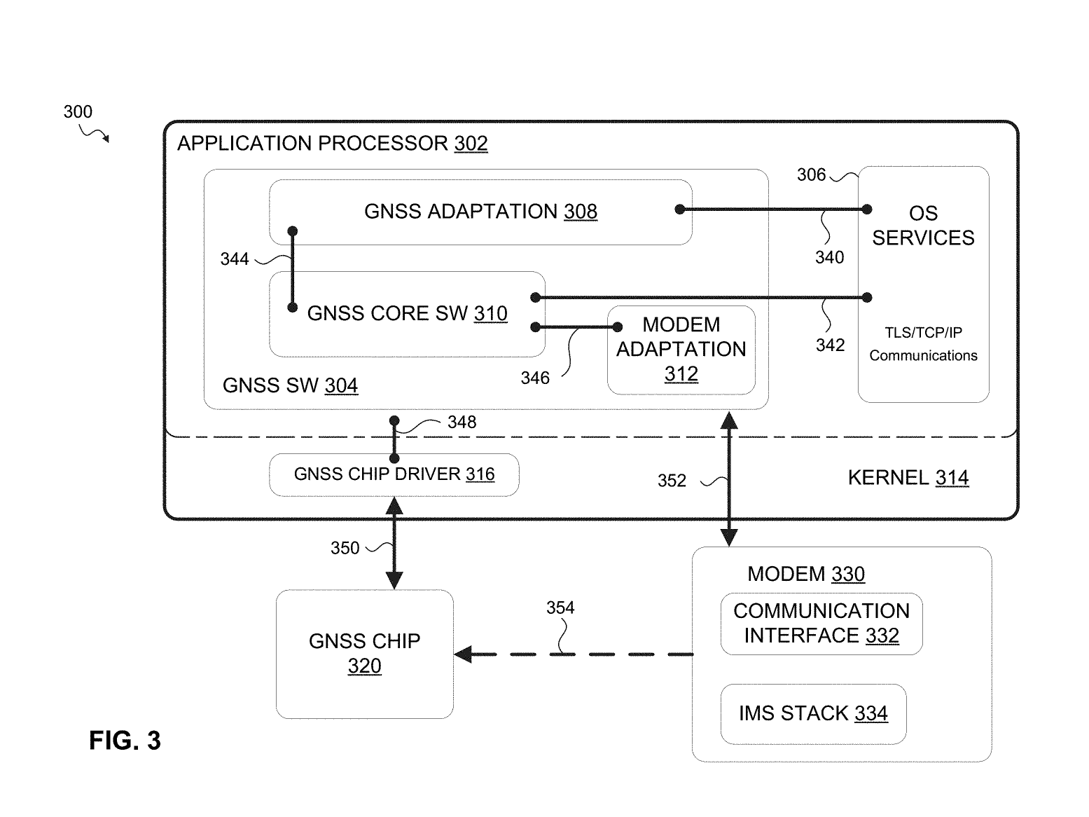

FIG. 3 illustrates a communication device 300 according to an exemplary aspect of the present disclosure. The communication device 300 can include an application processor 302, a GNSS chip 320 and a modem 330.

In one or more exemplary aspects, the communication device 300 is an example of the communication device 125. For example, in an exemplary aspect, the application processor 302 is a component of the controller 206, the GNSS chip 320 is a component of the GNSS receiver 202, and the modem 330 is a component of the communication transceiver 204.

The application processor 302 can include GNSS module 304, operation system (OS) services 306, and kernel 314. The kernel can include GNSS chip driver 316 configured to facilitate communications between the application processor 302 and the GNSS chip 320.

The GNSS module 304 can include GNSS adaptation module 308, GNSS core module 310, and modem adaptation module 312. The GNSS module 304 can include one or more computer programs and/or code configured to facilitate communications between the modem 330 and/or the GNSS chip 320 with the operating system of the communication device 300 and/or one or more applications running on the communication device 300. For example, the GNSS module 304 can be configured to interface with the modem 330 and/or the GNSS chip 320 to perform location reporting operations and/or location request operations, including requests for position assistance data from the SUPL server 140.

In an exemplary aspect, the GNSS core module 310 includes one or more computer programs and/or code configured to facilitate communications between the modem 330 and/or the GNSS chip 320 with the operating system of the communication device 300 and/or one or more applications running on the communication device 300. In an exemplary aspect, the GNSS core module 310 includes a secure user plane location (SUPL) positioning module that is configured to perform secure user plane communications with an assistance server, such as A-GPS server 140. In this example, the A-GPS server 140 can be a SUPL server 140 that stores position assistance information and is configured to establish one or more SUPL communication sessions with the communication device 300. In operation, the SUPL server 140 can communicate with the communication device 300 using SUPL signaling.

In an exemplary aspect, the GNSS adaptation 308 includes one or more computer programs and/or code configured to facilitate the communications between the GNSS core 310 and the OS services 306 via communication paths 340 and 344. The GNSS core module 310 can also communicate with the OS services 342 directly via the communication path 342. The modem adaptation module 312 includes one or more computer programs and/or code configured to facilitate the communications between the GNSS core 310 and the modem 330 via communication paths 346 and 352.

The OS services 306 can include one or more computer programs and/or code configured to establish secure connections with the SUPL server 140. For example, the OS services 306 can establish one or more bearers to facilitate communications between the application processor 302, namely the SUPL position module of the GNSS core module 310, and the SUPL server 140.

The GNSS chip driver 316 includes one or more computer programs and/or code configured to facilitate the communications between the application processor 302 and the GNSS chip 320 via communication paths 348 and 350. In an exemplary aspect, the GNSS chip 320 includes processor circuitry that is configured to receive GNSS signals from one or more GNSS satellites. The GNSS chip 320 can also receive position assistance information from the modem 330 via communication path 354. This information can be, for example, time information obtained by the modem from one or more wireless networks.

The modem 330 can include a communication interface module 332 and an internet protocol multimedia subsystem (IMS) stack 334.

The communication interface module 332 can be configured to facilitate communications between the modem 330 and the application processor 302 (e.g., modem adaptation module 312) via communication path 352. The communication interface module 332 can use one or more communication protocols to communicate with the application processor 302, such as remote procedure calls (RPC), customer attention (c-at) commands, mobile broadband interface model (MBIM) functions, and/or one or more other communication protocols as would be understood by one of ordinary skill in the relevant arts.

The IMS stack 334 is an architectural framework configured to establish one or more multimedia based sessions to deliver IP multimedia services between the communication device 300 and one or more other devices. For example, the IMS stack 334 can be configured to use Session Initiation Protocol (SIP) procedures to establish, manage and terminate sessions on one or more IP networks. In an exemplary aspect, the IMS stack 334 can establish the multimedia based sessions using the Long-term Evolution (LTE) protocol, but is not limited thereto.

In an exemplary aspect, the IMS stack 334 can be configured to facilitate communications with the SUPL server 140, including activating one or more packet data networks (PDN). For example, the IMS stack 334 can activate an emergency PDN in response to an emergency call (e.g., a call to 911) being performed. In an exemplary aspect, the emergency call is a Voice over LTE (VoLTE) emergency call, and the IMS stack 334 can activate the emergency PDN in response to the Voice over LTE (VoLTE) emergency call.

In operation, the communication device 300 will use a dedicated emergency PDN activated by the IMS stack 334 to perform the emergency call regardless of whether the communication device 300 includes a valid Universal Integrated Circuit Card (UICC) or Subscriber identity module (SIM) card to authenticate the communication device 300 on one or more wireless networks. That is, the communication device 300 will be able to make an emergency call even if the communication device cannot be authenticated on the available wireless communication network(s).

However, the emergency PDN is typically not made available to the application processor 302, namely the OS services 306, and is made available only to the modem 330. In this case, where the communication device 300 does not include a UICC or SIM card to authenticate with a wireless network, the OS services 306 will be unable to establish communications with the SUPL server 140 to obtain position assistance information using one or more SUPL communication sessions.

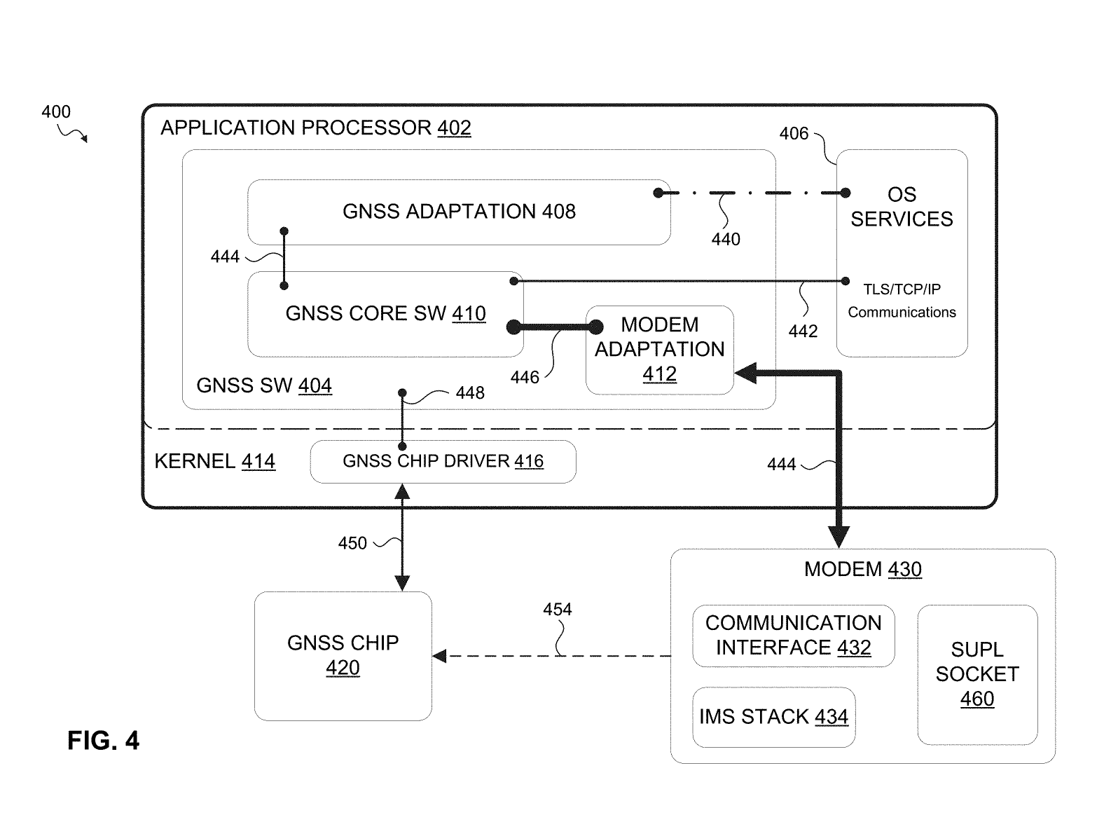

FIG. 4 illustrates a communication device 400 according to an exemplary aspect of the present disclosure. The communication device 400 can include an application processor 402, a GNSS chip 420 and a modem 430.

In one or more exemplary aspects, the communication device 400 is an example of the communication device 125. For example, in an exemplary aspect, the application processor 402 is a component of the controller 206, the GNSS chip 420 is a component of the GNSS receiver 202, and the modem 430 is a component of the communication transceiver 204.

The application processor 402 can include GNSS module 404, operation system (OS) services 406, and kernel 414. The kernel can include GNSS chip driver 416 configured to facilitate communications between the application processor 402 and the GNSS chip 420.

The GNSS module 404 can include GNSS adaptation module 408, GNSS core module 410, and modem adaptation module 412. The GNSS module 404 can include one or more computer programs and/or code configured to facilitate communications between the modem 430 and/or the GNSS chip 420 with the operating system of the communication device 400 and/or one or more applications running on the communication device 400. For example, the GNSS module 404 can be configured to interface with the modem 430 and/or the GNSS chip 420 to perform location reporting operations and/or location request operations, including requests for position assistance data from the SUPL server 140.

In an exemplary aspect, the GNSS core module 410 includes one or more computer programs and/or code configured to facilitate communications between the modem 430 and/or the GNSS chip 420 with the operating system of the communication device 400 and/or one or more applications running on the communication device 400. In an exemplary aspect, the GNSS core module 410 can include a secure user plane location (SUPL) positioning module similar to the GNSS core module 310. The SUPL position module can be configured to perform secure user plane communications with the SUPL server 140.

In an exemplary aspect, the GNSS adaptation 408 includes one or more computer programs and/or code configured to facilitate the communications between the GNSS core 410 and the OS services 406 via communication paths 440 and 444. The GNSS core module 410 can also communicate with the OS services 442 directly via the communication path 442. The modem adaptation module 412 includes one or more computer programs and/or code configured to facilitate the communications between the GNSS core 410 and the modem 430 via communication paths 446 and 452.

The OS services 406 can include one or more computer programs and/or code configured to establish secure connections with the SUPL server 140. For example, the OS services 406 can establish one or more bearers to facilitate communications between the application processor 402, namely the SUPL position module of the GNSS core module 410, and the SUPL server 140.

The GNSS chip driver 416 includes one or more computer programs and/or code configured to facilitate the communications between the application processor 402 and the GNSS chip 420 via communication paths 448 and 450. In an exemplary aspect, the GNSS chip 420 includes processor circuitry that is configured to receive GNSS signals from one or more GNSS satellites. The GNSS chip 420 can also receive position assistance information from the modem 430 via communication path 454. This information can be, for example, time information obtained by the modem from one or more wireless networks.

In an exemplary aspect, the modem 430 includes a communication interface module 432, IMS stack 434, and SUPL socket 460. As explained in detail below, the modem 430 is similar to the modem 330 but includes SUPL socket 460 that enables the establishment of SUPL communication sessions with the SUPL server 140.

The communication interface module 432 can be configured to facilitate communications between the modem 430 and the application processor 402 (e.g., modem adaptation module 412) via communication path 452. The communication interface module 432 can use one or more communication protocols to communicate with the application processor 402, such as remote procedure calls (RPC), customer attention (c-at) commands, mobile broadband interface model (MBIM) functions, and/or one or more other communication protocols as would be understood by one of ordinary skill in the relevant arts.

The IMS stack 434 is an architectural framework configured to establish one or more multimedia based sessions to deliver IP multimedia services between the communication device 400 and one or more other devices. For example, the IMS stack 434 can be configured to use Session Initiation Protocol (SIP) procedures to establish, manage and terminate sessions on one or more IP networks. The IMS stack 434 can be configured to facilitate communications with the SUPL server 140, including activating one or more packet data networks (PDN). For example, the IMS stack 434 can activate an emergency PDN in response to an emergency call (e.g., a call to 911) being performed. In an exemplary aspect, the IMS stack 434 can establish the multimedia based sessions using the Long-term Evolution (LTE) protocol, but is not limited thereto.

In an exemplary aspect, the SUPL socket 460 includes one or more computer programs and/or code configured to listen for SUPL initialization messages generated by the SUPL server 140. For example, the SUPL socket 460 can be configured to listen on a user datagram protocol (UDP) socket for incoming SUPL initialization messages from the SUPL server 140. The SUPL socket 460 can also be configured to facilitate the exchange of communications with the SUPL server 140. For example, the SUPL socket 460 can perform a SUPL message exchange with the SUPL server 140 using one or more secure connections, such as connections secured using the transport layer security (TLS) protocol.

During an emergency call, communication device 400 will use a dedicated emergency PDN activated by the IMS stack 434 for SUPL message communications with the SUPL server 140. This emergency PDN will be available to the communication device 400 regardless of whether the communication device 400 includes a UICC/SIM card to authenticate the communication device 400 on one or more wireless networks.

As discussed above, the emergency PDN is not typically not made available to the application processor 402, namely the OS services 406, and is made available only to the modem 430.

In exemplary aspects, because the SUPL socket 460 is included within the modem 430, the SUPL socket 460 will have access to the emergency PDN activated by the IMS stack 434. In operation, the SUPL socket 430 can establish communications with the SUPL server 140 using the emergency PDN to obtain position assistance data using one or more SUPL communication sessions. In this example, the communication device 400 will be able to communicate with the SUPL server 140 even if the communication device 400 does not include a UICC or SIM card to authenticate with a wireless network. In this regards, the communication device 400 will be operable to obtain position assistance data from the SUPL server 140 during an emergency call even if the communication device 400 is unable to be authenticated on a wireless communication network (i.e., the communication device 400 does not include a valid UICC/SIM).

In operation, the GNSS core module 410 can obtain position assistance data from the SUPL server 140 via the SUPL socket 460. For example, the GNSS core module 410 can communicate with the modem 430 via the modem adaptation 412 and communication paths 444 and 446. This operation is illustrated in FIG. 4 by the heavier weighted communication paths 444 and 446. Further, the communication path 440 is illustrated in partially broken line to emphasize that the SUPL communication session is not established through the OS services 406 (as described above with reference to FIG. 3).

### Exemplary Communication Method

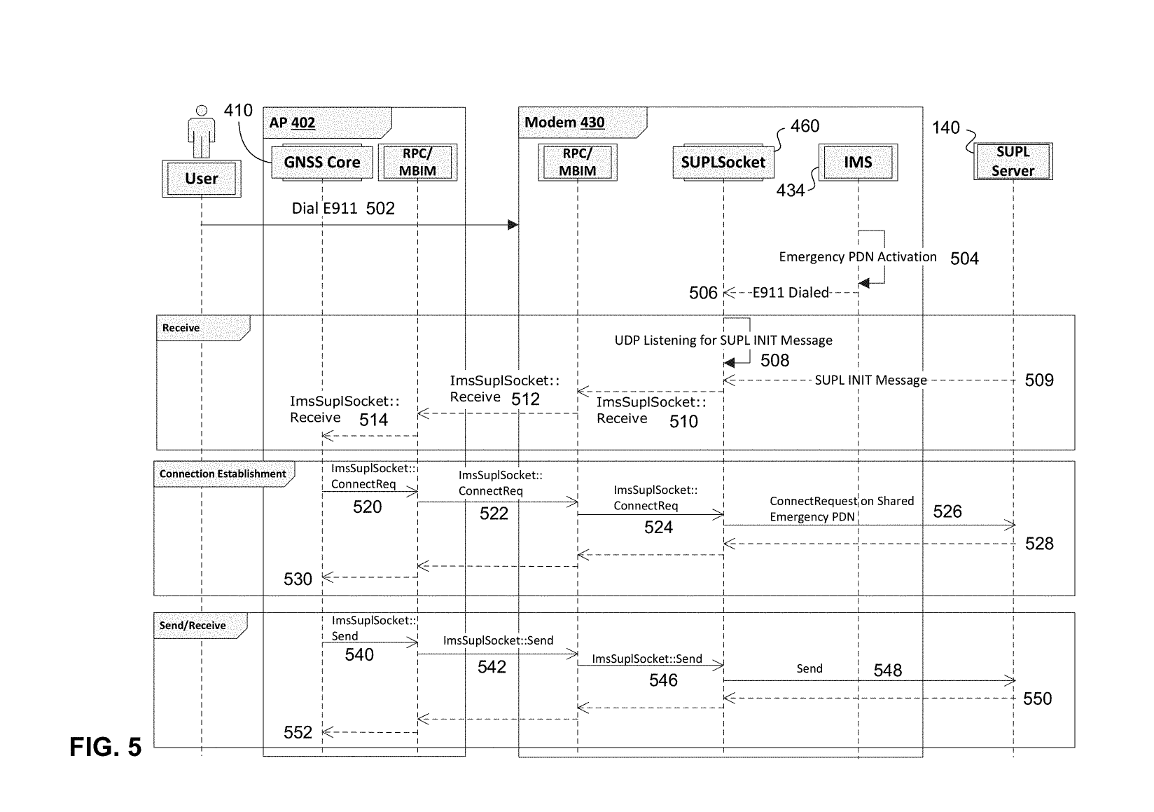

FIG. 5 illustrates a communication method 500 according to an exemplary aspect of the present disclosure. The flowchart is described with continued reference to FIGS. 1-4. The steps of the method are not limited to the order described below, and the various steps may be performed in a different order. Further, two or more steps of the method may be performed simultaneously with each other.

The method of flowchart 500 begins at step 502 where the modem (e.g., modem 430) receives a notice that an emergency call has been initiated, for example, by a user of the communication device. In operation, the notice of the emergency call can be provided to the modem 430 by the application processor 402.

After step 502, the flowchart 500 transitions to step 504, where an emergency packet data network (PDN) is activated in response to the initiation of the emergency call. In an exemplary aspect, the emergency PDN can be activated by the IMS stack 434. In some cases, the IMS stack 434 and the wireless network can cooperatively activate the emergency PDN.

After step 504, the flowchart 500 transitions to step 506, where the SUPL socket 460 receives a message from the IMS stack 434 indicating that an emergency call has been initiated and the emergency PDN has been activated.

After step 506, the flowchart 500 transitions to step 508, where the SUPL socket 460 listens for SUPL initialization (SUPL INIT) messages generated by the SUPL server 140. For example, the SUPL socket 460 can begin listening in response to the emergency PDN being activated. In an exemplary aspect, the SUPL socket 460 can be configured to listen on a user datagram protocol (UDP) socket for incoming SUPL initialization messages from the SUPL server 140.

After step 508, the flowchart 500 transitions to step 509, where the SUPL socket 460 receives a SUPL initialization (SUPL INIT) message from the SUPL server 140. The SUPL initialization message can be generated and provided by the SUPL server 140 in response to the dialing of an emergency number (e.g., 911) by the user. In an exemplary aspect, the SUPL initialization message can be generated and provided by the SUPL server 140 in response to the activation of emergency PDN by the IMS stack 434, which can be activated in response to the dialing of the emergency number.

After step 509, the flowchart 500 transitions to steps 510-514, where the SUPL socket 460 provides the SUPL INIT message to the application processor 402. In an exemplary embodiment, the SUPL INIT message is provided to the GNSS core module 410 (step 514). The SUPL INIT message can be sent from the SUPL socket 460 using one or more communication protocols, including, remote procedure calls (RPC), customer attention (c-at) commands, mobile broadband interface model (MBIM) functions, and/or one or more other communication protocols as would be understood by one of ordinary skill in the relevant arts.

After step 514, the flowchart 500 transitions to steps 520-524, where the SUPL socket 460 is requested to establish a secure connection with the SUPL server 140. For example, the GNSS core module 410 can generate a connection request message (ConnectReq) and provide the connection request message to the SUPL socket 460 to request that the SUPL socket 460 establish the connection with the SUPL server 140. The connection request message can be sent from the GNSS core module 410 using one or more communication protocols, including, remote procedure calls (RPC), customer attention (c-at) commands, mobile broadband interface model (MBIM) functions, and/or one or more other communication protocols as would be understood by one of ordinary skill in the relevant arts.

After step 524, the flowchart 500 transitions to step 526, where the SUPL socket 460 requests to establish a connection with the SUPL server 140 in response to receiving the connection request message from the GNSS core module 410. For example, the SUPL socket 460 can pass the connection request message received from the GNSS core module 410 to the SUPL server 140. Alternatively, the SUPL socket 460 can generate a connection request based on the received connection request message and provide the connection request to the SUPL server 140. In an exemplary aspect, the SUPL socket 460 can use one or more secure connections when providing the connection request message/connection request to the SUPL server 140. For example, the connection can be secured using the transport layer security (TLS) protocol.

After step 526, the flowchart 500 transitions to step 528, where the SUPL socket 460 receives an acknowledgement message from the SUPL server 140 in response to the SUPL server 140 successfully receiving the connection request message/connection request. The acknowledgment message can be passed to the GNSS core module 410 (step 530). In an exemplary aspect, the acknowledgement message acknowledges that a connection has been established with the SUPL server 140.

After step 530, the flowchart 500 transitions to steps 540-550, where a SUPL message exchange is performed. At step 540, the GNSS core module 410 can generate a request message and provide the request message to the SUPL socket 460 (steps 540-546) to request position assistance data from the SUPL server 140.

In an exemplary aspect, the GNSS core module 410 can communicate with the SUPL socket 460 of the modem 430 via the modem adaptation 412 and communication paths 444 and 446. The SUPL socket 460 can then request position assistance data from the SUPL server 140 (step 548). In an exemplary aspect, the request for position assistance data can be communicated to the SUPL server 140 using the emergency PDN established by the IMS stack 434.

At step 550, the SUPL server 140 can provide position assistance data to the SUPL socket 460. In an exemplary aspect, the position assistance data can be communicated to the SUPL socket 460 using the emergency PDN established by the IMS stack 434.

The SUPL socket 460 can then provide the position assistance data to the GNSS core module 410 (step 552). The position assistance data can be passed from the SUPL socket 460 to the GNSS core module 410 via the modem adaptation 412 and communication paths 444 and 446.

### Examples

Example 1 is a modem for wireless communication, comprising: an internet protocol multimedia subsystem (IMS) stack configured to establish an emergency packet data network (PDN); and a secure user plane location (SUPL) socket configured to: establish a secure connection with a position assistance server using the emergency PDN; and provide a SUPL message to the position assistance server via the secure connection.

In Example 2, the subject matter of Example 1, wherein the SUPL socket is further configured to: receive, from the position assistance server, an initialization message generated in response to establishment of the emergency PDN; and provide the received initialization message to a navigation core operable to communicate with the modem.

In Example 3, the subject matter of Example 2, wherein the SUPL socket is configured to establish the secure connection based on the received initialization message.

In Example 4, the subject matter of Example 2, wherein the SUPL socket is further configured to: listen for the initialization message on a user datagram protocol (UDP) socket; and receive the received initialization message on the UDP socket.

In Example 5, the subject matter of Example 2, wherein the SUPL socket is further configured to: receive a connection request from the navigation core, the establishing of the secure connection being based on the connection request, wherein the connection request is based on the received initialization message provided to the navigation core.

In Example 6, the subject matter of Example 2, wherein the SUPL socket is configured to provide the received initialization message to the navigation core via one or more of the following: a mobile broadband interface model (MBIM) interface, a remote procedure calling interface, and a customer attention (c-at) command interface.

In Example 7, the subject matter of Example 2, wherein the initialization message is a SUPL initialization message.

In Example 8, the subject matter of Example 1, wherein the SUPL socket is further configured to: receive position assistance data from the position assistance server based on the SUPL message.

In Example 9, the subject matter of Example 8, wherein the SUPL socket is further configured to: provide the received position assistance data to the navigation core.

In Example 10, the subject matter of Example 1, wherein the position assistance server is a SUPL server that stores position assistance data.

Example 11 is a communication device comprising the modem of Example 1.

Example 12 is a communication device, comprising: an application processor including a navigation core configured to generate a connection request; and a modem including: an internet protocol multimedia subsystem (IMS) stack configured to establish an emergency packet data network (PDN); and a secure user plane location (SUPL) socket configured to: receive an initialization message generated in response to establishment of the emergency PDN; provide the received initialization message to the navigation core; receive the connection request from the navigation core, the connection request being based the initialization message provided to the navigation core; establish a secure connection with a position assistance server using the emergency PDN, the establishing of the secure connection being based on the connection request; provide a SUPL message to the position assistance server via the secure connection; receive position assistance data from the position assistance server based on the SUPL message.

In Example 13, the subject matter of Example 12, wherein the SUPL socket is further configured to: provide the received position assistance data to the navigation core of the application processor.

In Example 14, the subject matter of Example 12, wherein: the initialization message is a SUPL initialization message; and the position assistance server is a SUPL server that stores the position assistance data.

Example 15 is a communication method of communication device including a navigation core and a modem having a secure user plane location (SUPL) socket, the method comprising: establishing, using the SUPL socket, a secure connection with a position assistance server; providing, using the SUPL socket, a SUPL message from the navigation core to the position assistance server via the secure connection.

In Example 16, the subject matter of Example 15, further comprising: receiving, by the SUPL socket, an initialization message from the position assistance server; and providing, by the SUPL socket, the received initialization message to the navigation core.

In Example 17, the subject matter of Example 15, wherein the initialization message is provided to the navigation core via one or more of the following: a mobile broadband interface model (MBIM) interface, a remote procedure calling interface, and a customer attention (c-at) command interface.

In Example 18, the subject matter of Example 16, wherein the establishing of the secure connection with the position assistance server is based on the received initialization message.

In Example 19, the subject matter of Example 16, further comprising: listening, by the SUPL socket, for the initialization message on a user datagram protocol (UDP) socket; and receiving, by the SUPL socket, the initialization message on the UDP socket.

In Example 20, the subject matter of Example 16, further comprising: receiving, by the SUPL socket, a connection request from the navigation core, wherein the establishing of the secure connection is based on the connection request, and wherein the connection request is based on the received initialization message provided to the navigation core.

In Example 21, the subject matter of Example 16, wherein the initialization message is a SUPL initialization message.

In Example 22, the subject matter of Example 15, further comprising: receiving, by the SUPL socket, position assistance data from the position assistance server based on the SUPL message.

In Example 23, the subject matter of Example 22, further comprising: providing, by the SUPL socket, the received position assistance data to the navigation core.

In Example 24, the subject matter of Example 15, wherein the SUPL message is provided to the position assistance server using an emergency packet data network (PDN).

Example 25 is a non-transitory computer-readable storage medium with an executable program stored thereon, wherein the program instructs a processor to perform the method of claim 15.

In Example 26, the subject matter of any of Examples 2-5, wherein the SUPL socket is configured to provide the received initialization message to the navigation core via one or more of the following: a mobile broadband interface model (MBIM) interface, a remote procedure calling interface, and a customer attention (c-at) command interface.

In Example 27, the subject matter of any of Examples 2-5 and 26, wherein the initialization message is a SUPL initialization message.

In Example 28, the subject matter of any of Examples 1-5, 26, and 27, wherein the SUPL socket is further configured to: receive position assistance data from the position assistance server based on the SUPL message.

In Example 29, the subject matter of Example 28, wherein the SUPL socket is further configured to: provide the received position assistance data to the navigation core.

In Example 30, the subject matter of any of Examples 1-5 and 26-29, wherein the position assistance server is a SUPL server that stores position assistance data.

Example 31 is a communication device comprising the modem of any of Examples 1-5 and 26-30.

Example 32 is an apparatus comprising means to perform the method as described in any of Examples 15-25.

Example 33 is an apparatus substantially as shown and described.

Example 34 is a method substantially as shown and described.

### CONCLUSION

The aforementioned description of the specific aspects will so fully reveal the general nature of the disclosure that others can, by applying knowledge within the skill of the art, readily modify and/or adapt for various applications such specific aspects, without undue experimentation, and without departing from the general concept of the present disclosure. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one aspect,” “an aspect,” “an exemplary aspect,” etc., indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it is submitted that it is within the knowledge of one skilled in the art to affect such feature, structure, or characteristic in connection with other aspects whether or not explicitly described.

The exemplary aspects described herein are provided for illustrative purposes, and are not limiting. Other exemplary aspects are possible, and modifications may be made to the exemplary aspects. Therefore, the specification is not meant to limit the disclosure. Rather, the scope of the disclosure is defined only in accordance with the following claims and their equivalents.

Aspects may be implemented in hardware (e.g., circuits), firmware, software, or any combination thereof. Aspects may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

For the purposes of this discussion, the term “processor circuitry” shall be understood to be circuit(s), processor(s), logic, or a combination thereof. For example, a circuit can include an analog circuit, a digital circuit, state machine logic, other structural electronic hardware, or a combination thereof. A processor can include a microprocessor, a digital signal processor (DSP), or other hardware processor. The processor can be “hard-coded” with instructions to perform corresponding function(s) according to aspects described herein. Alternatively, the processor can access an internal and/or external memory to retrieve instructions stored in the memory, which when executed by the processor, perform the corresponding function(s) associated with the processor, and/or one or more functions and/or operations related to the operation of a component having the processor included therein.

In one or more of the exemplary aspects described herein, processor circuitry can include memory that stores data and/or instructions. The memory can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

Examples of user devices, communication devices, user equipment, and/or mobile devices can include (but are not limited to) a mobile computing device—such as a laptop computer, a tablet computer, a mobile telephone or smartphone, a “phablet,” a personal digital assistant (PDA), navigation device (e.g., GPS receiver) and the like; and a wearable computing device—such as a computerized wrist watch or “smart” watch, computerized eyeglasses, and the like. In some aspects, the user/mobile device may be a stationary, including, for example, a stationary computing device—such as a personal computer (PC), a desktop computer, a computerized kiosk, an automotive/aeronautical/maritime in-dash computer terminal, automotive/aeronautical/maritime in-dash navigation systems, etc.

As will be apparent to a person of ordinary skill in the art based on the teachings herein, exemplary aspects are not limited to wireless communications conforming to Long-Term Evolution (LTE) protocols. For example, one or more of the exemplary aspects described herein can be implemented using one or more wireless communications conforming to one or more other communication standards/protocols, including (but not limited to), Evolved High-Speed Packet Access (HSPA+), Wideband Code Division Multiple Access (W-CDMA), CDMA2000, Time Division-Synchronous Code Division Multiple Access (TD-SCDMA), Global System for Mobile Communications (GSM), General Packet Radio Service (GPRS), Enhanced Data Rates for GSM Evolution (EDGE), and/or Worldwide Interoperability for Microwave Access (WiMAX) (IEEE 802.16), to one or more non-cellular communication standards, including (but not limited to) WLAN (IEEE 802.11), Bluetooth, Near-field Communication (NFC) (ISO/IEC 18092), ZigBee (IEEE 802.15.4), and/or Radio-frequency identification (RFID). These various standards and/or protocols are each incorporated herein by reference in their entirety.

What is claimed is:

1. A modem for wireless communication, comprising:
an internet protocol multimedia subsystem (IMS) stack configured to establish an emergency packet data network (PDN); and
a secure user plane location (SUPL) socket configured to:
establish a secure connection with a position assistance server using the emergency PDN; and
provide a SUPL message to the position assistance server via the secure connection.

2. The modem of claim 1, wherein the SUPL socket is further configured to:
receive, from the position assistance server, an initialization message generated in response to establishment of the emergency PDN; and
provide the received initialization message to a navigation core operable to communicate with the modem.

3. The modem of claim 2, wherein the SUPL socket is configured to establish the secure connection based on the received initialization message.

4. The modem of claim 2, wherein the SUPL socket is further configured to:
listen for the initialization message on a user datagram protocol (UDP) socket; and
receive the received initialization message on the UDP socket.

5. The modem of claim 2, wherein the SUPL socket is further configured to:
receive a connection request from the navigation core, the establishing of the secure connection being based on the connection request, wherein the connection request is based on the received initialization message provided to the navigation core.

6. The modem of claim 2, wherein the SUPL socket is configured to provide the received initialization message to the navigation core via one or more of the following: a mobile broadband interface model (MBIM) interface, a remote procedure calling interface, and a customer attention (c-at) command interface.

7. The modem of claim 2, wherein the initialization message is a SUPL initialization message.

8. The modem of claim 1, wherein the SUPL socket is further configured to:
receive position assistance data from the position assistance server based on the SUPL message.

9. The modem of claim 8, wherein the SUPL socket is further configured to:
provide the received position assistance data to the navigation core.

10. The modem of claim 1, wherein the position assistance server is a SUPL server that stores position assistance data.

11. A communication device comprising the modem of claim 1.

12. A communication device, comprising:
an application processor including a navigation core configured to generate a connection request; and
a modem including:
an internet protocol multimedia subsystem (IMS) stack configured to establish an emergency packet data network (PDN); and
a secure user plane location (SUPL) socket configured to:
receive an initialization message generated in response to establishment of the emergency PDN;
provide the received initialization message to the navigation core;
receive the connection request from the navigation core, the connection request being based the initialization message provided to the navigation core;
establish a secure connection with a position assistance server using the emergency PDN, the establishing of the secure connection being based on the connection request;
provide a SUPL message to the position assistance server via the secure connection;
receive position assistance data from the position assistance server based on the SUPL message.

13. The communication device of claim 12, wherein the SUPL socket is further configured to:
provide the received position assistance data to the navigation core of the application processor.

14. The communication device of claim 12, wherein:
the initialization message is a SUPL initialization message; and
the position assistance server is a SUPL server that stores the position assistance data.

15. A communication method of communication device including a navigation core and a modem having a secure user plane location (SUPL) socket, the method comprising:
establishing, using the SUPL socket, a secure connection with a position assistance server;
providing, using the SUPL socket, a SUPL message from the navigation core to the position assistance server via the secure connection.

16. The communication method of claim 15, further comprising:
receiving, by the SUPL socket, an initialization message from the position assistance server; and
providing, by the SUPL socket, the received initialization message to the navigation core.

17. The communication method of claim 16, wherein the initialization message is provided to the navigation core via one or more of the following: a mobile broadband interface model (MBIM) interface, a remote procedure calling interface, and a customer attention (c-at) command interface.

18. The communication method of claim 16, wherein the establishing of the secure connection with the position assistance server is based on the received initialization message.

19. The communication method of claim 16, further comprising:
listening, by the SUPL socket, for the initialization message on a user datagram protocol (UDP) socket; and
receiving, by the SUPL socket, the initialization message on the UDP socket.

20. The communication method of claim 16, further comprising:
receiving, by the SUPL socket, a connection request from the navigation core,
wherein the establishing of the secure connection is based on the connection request, and
wherein the connection request is based on the received initialization message provided to the navigation core.

21. The communication method of claim 16, wherein the initialization message is a SUPL initialization message.

22. The communication method of claim 15, further comprising:
receiving, by the SUPL socket, position assistance data from the position assistance server based on the SUPL message.

23. The communication method of claim 22, further comprising:
providing, by the SUPL socket, the received position assistance data to the navigation core.

24. The communication method of claim 15, wherein the SUPL message is provided to the position assistance server using an emergency packet data network (PDN).

25. A non-transitory computer-readable storage medium with an executable program stored thereon, wherein the program instructs a processor to perform the method of claim 15.
